(19) United States
(12) Patent Application Publication
(10) Pub. No.: US 2024/0400006 A1
(43) Pub. Date: Dec. 5, 2024

(54) SYSTEM FOR MITIGATION OF WHEEL DEBRIS PACKING

(71) Applicant: FORD GLOBAL TECHNOLOGIES, LLC, Dearborn, MI (US)

(72) Inventors: Jim Stevens, Bellevlle, MI (US); Keith Weston, Canton, MI (US); Brendan Diamond, Grosse Pointe, MI (US); Matthew Johnson, Toledo, OH (US)

(21) Appl. No.: 18/204,011

(22) Filed: May 31, 2023

(51) Int. Cl. B60S 1/68

(52) U.S. Cl. CPC B60S 1/68; B08B 3/02; B08B 3/10; B08B 13/00; B08B 2203/007

(57) ABSTRACT

A wheel assembly cleaning system may include a sensor network disposed proximate to the wheel assembly to detect fouling inside the wheel assembly, a controller operably coupled to the sensor network to determine a trigger condition associated with detection of the fouling inside the wheel assembly, and a fluid dispensing assembly disposed proximate to an internal side of the wheel assembly to apply a fluid to the inside of the wheel assembly under control of the controller responsive to the trigger condition. The fluid dispensing assembly may include a reservoir of the fluid, a pump providing motive force for application of the fluid, and a flow controller to direct the fluid to the inside of the wheel assembly.

### TECHNICAL FIELD

Example embodiments generally relate to vehicle control systems and, more particularly, relate to a system for mitigating wheel debris packing.

### BACKGROUND

In adverse weather or other driving conditions, snow, sand, dirt, ice or other debris may become packed in vehicle wheel assemblies. This phenomenon is already somewhat frequent in the context of conventional wheel assemblies (i.e., wheel assemblies with pneumatic tires), but is expected to be even more of an issue in the future with airless tires. When it occurs, the increased weight and changes in weight balance can cause vibrations during wheel rotation that decrease occupant comfort.

Accordingly, it may be desirable to develop ways to prevent fouling due to the buildup or packing of debris in wheel assemblies.

### BRIEF SUMMARY OF SOME EXAMPLES

In accordance with an example embodiment, a wheel assembly cleaning system for a vehicle may be provided. The wheel assembly cleaning system may include a sensor network disposed proximate to the wheel assembly to detect fouling of the wheel assembly, a controller operably coupled to the sensor network to determine a trigger condition associated with detection of the fouling inside the wheel assembly, and a fluid dispensing assembly disposed proximate to an internal side of the wheel assembly to apply a fluid to the inside of the wheel assembly under control of the controller responsive to the trigger condition. The fluid dispensing assembly may include a reservoir of the fluid, a pump providing motive force for application of the fluid, and a flow controller to direct the fluid to the inside of the wheel assembly.

In another example embodiment, a fluid dispensing assembly for cleaning a wheel assembly of a vehicle may be provided. The fluid dispensing assembly may include a reservoir of fluid, a pump operably coupled to the reservoir to provide motive force for application of the fluid, and a flow controller operably coupled to a controller of the vehicle to direct the fluid to the inside of a wheel assembly of the vehicle responsive to a sensor network disposed proximate to the wheel assembly detecting fouling inside the wheel assembly and the controller determining a trigger condition associated with detection of the fouling inside the wheel assembly.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a control system of a vehicle in accordance with an example embodiment;

FIG. 2 illustrates a block diagram of various components of the control system in accordance with an example embodiment;

FIG. 3 illustrates a block diagram of some components of a fluid dispensing assembly in accordance with an example embodiment;

FIG. 4 illustrates a block diagram of some alternative components of a fluid dispensing assembly in accordance with an example embodiment;

FIG. 5 illustrates a block diagram of another set of alternative components of a fluid dispensing assembly in accordance with an example embodiment; and

FIG. 6 illustrates a block diagram of still another set of alternative components of a fluid dispensing assembly in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

The general problem of unwanted debris buildup near wheels can be an irritant to drivers as well as other vehicle occupants. This phenomenon has not gone without consideration in the past. In this regard, the particular issue of cleaning a roadway in front of the tires of a vehicle, or cleaning a wheel well in which the tires rotate, has previously received consideration through the devising of technical solutions aimed at curing these problems. However, these earlier technical solutions aimed primarily at cleaning the area around the tire instead of cleaning the wheel assembly itself. Thus, for example, the packing of debris in wheel assemblies, which may generally be referred to as “fouling” of the wheel assemblies due to debris buildup, has not yet been specifically addressed through technical means. Example embodiments aim to define a system, and specific component arrangements, that provide an effective way to mitigate fouling inside the wheel assembly. Since it should be understood that wheels, and correspondingly also components of the wheel assembly, often turn during routine vehicle operation, references to an “inside” or “internal” side of the wheel assembly are intended to apply to a side of the wheel assembly that is closest to or faces a chassis of the vehicle.

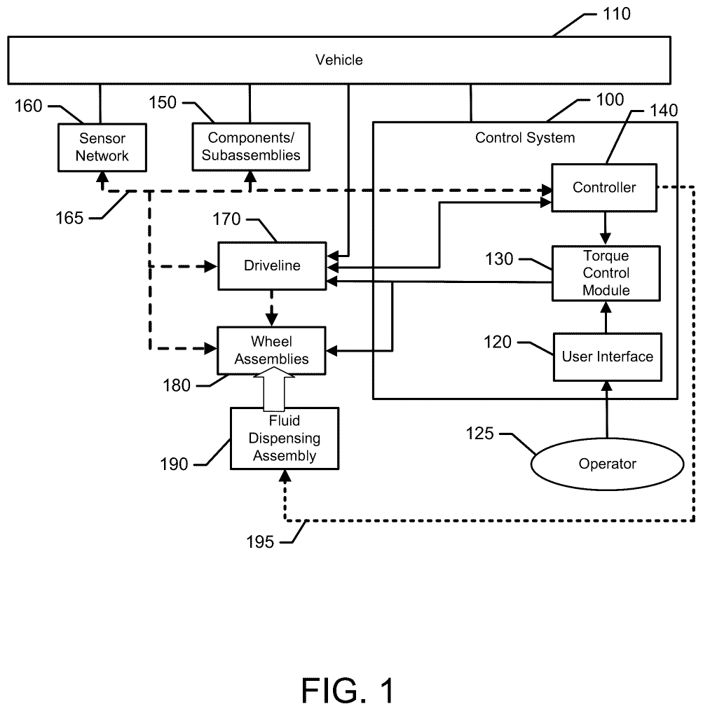

In this regard, FIG. 1 illustrates a block diagram of a control system 100 of an example embodiment. The components of the control system 100 may be incorporated into a vehicle 110 (e.g., via being operably coupled to a chassis of the vehicle 110, various components of the vehicle 110 and/or electronic control systems of the vehicle 110). Of note, although the components of FIG. 1 may be operably coupled to the vehicle 110, it should be appreciated that such connection may be either direct or indirect. Moreover, some of the components of the control system 100 may be connected to the vehicle 110 via intermediate connections to other components either of the chassis or of other electronic and/or mechanical systems or components.

The control system 100 may have a normal mode of operation in which any number of input devices in the form of control pedals, the steering wheel (or hand wheel), and various other selectors (e.g., buttons, levers, soft keys, etc.) contribute as inputs for normal operation of the vehicle. The pedals may include a brake pedal and a throttle (e.g., a gas or other speed control pedal) pivotally mounted to the floor of the vehicle 110, and operable by an operator 125. However, the normal mode of operation may not be desirable for all cases. Moreover, selectable other modes of operation, including one or more off-road driver assistance modes, parking modes, turn assist modes, etc., may also exist. Accordingly, the control system 100 of some example embodiments may further include a user interface 120. The operator 125 may operate the user interface 120, which may include or define a mode selector to shift or transition out of the normal mode of operation and into any of the other modes of operation. In one example embodiment, the other modes of operation that can be selected by the operator 125 via the user interface 120 may include a wheel assembly cleaning mode, in which monitoring for fouling of the wheel assemblies of the vehicle 110 may be conducted to detect a trigger condition that may be initiated to clean the wheel assemblies as described in greater detail below.

Of note, although the term wheel assembly cleaning mode has been described above as a selectable option outside the normal mode of operation, it need not be selectable, and may be an inherent and always operable feature of the normal mode in some cases. Furthermore, the reference to the wheel assembly cleaning mode herein as being the mode in which example embodiments are performed is only provided as an example, and not for purposes of limitation. Thus, the name of the mode in which example embodiments may be applied is not important, and certainly not limiting. Moreover, wheel assembly cleaning could be a part of another mode entirely, or not a selectable mode at all. Thus, as noted above, other terms like normal mode, off-road driver assistance mode, parking mode, or any other mode in which the functionality described herein is applied, are also possible modes in which wheel assembly cleaning as described herein may be applicable.

The control system 100 of example embodiments may also include the torque control module 130, which may be part of or otherwise operably coupled to a controller 140. The torque control module 130 may be configured to determine positive torque (e.g., propulsive torque) and/or negative torque (e.g., brake torque, regenerative torque, etc.) to be applied to the wheels, individually, in pairs or collectively (e.g., depending on driveline state and/or vehicle type) as described herein based on inputs from any or all of the controller 140, the user interface 120 or other components of the vehicle 110. In some cases, the controller 140 may be part of an electronic control system of the vehicle 110 that is configured to perform other tasks related or not related to propulsive and braking control or performance management. However, the controller 140 could be a dedicated or standalone controller in some cases.

In an example embodiment, the controller 140 may receive information that is used to determine vehicle status from various components or subassemblies 150 of the vehicle 110. Additionally or alternatively, various sensors that may be operably coupled to the components or subassemblies 150 may be included, and may provide input to the controller 140 that is used in determining vehicle status. Such sensors may be part of a sensor network 160 and sensors of the sensor network 160 may be operably coupled to the controller 140 (and/or the components or subassemblies 150) via a vehicle communication bus (e.g., a controller area network (CAN) bus) 165. However, the vehicle communication bus 165 may be dedicated to a particular function (e.g., wheel assembly cleaning) in some cases as well.

The components or subassemblies 150 may include, for example, the steering wheel of the vehicle, a brake assembly, a propulsion system and/or a wheel assembly 180 of the vehicle 110. The brake assembly may be configured to provide braking inputs to braking components of the vehicle 110 (e.g., friction brakes and electrical methods of braking such as regenerative braking) based on a braking torque determined by the controller 140 and/or torque control module 130. In some cases, the brake assembly may include an electric brake boost (EBB) system, which uses electric brake boosters to sense driver input and reduce the amount of pedal pressure needed for braking. The propulsion system may include a gas engine, electric motor, or any other suitable propulsion device. Thus, example embodiments may apply to electric vehicles (EVs), hybrid electric vehicles (HEV), battery electric vehicle (BEV), internal combustion engine (ICE) vehicles, and/or the like.

The controller 140 and/or torque control module 130 may be configured to determine positive and negative torque inputs for provision to components of a driveline 170 (e.g., driveshaft, differential(s), axle shaft(s), etc.) and wheel assemblies 180 of the vehicle 110. Thus, for example, the torque control module 130 may determine positive torque inputs for provision to the propulsion system to apply propulsive torque to the wheel assemblies 180 of the wheel assembly of the vehicle 110 via the driveline 170, and determine negative torque inputs for provision to the wheel assemblies 180 in the form of braking torque, regenerative torque, or the like. Moreover, one or more corresponding sensors of the sensor network 160 that may be operably coupled to the brake assembly and/or the wheel assembly may provide information relating to brake torque, brake torque rate, vehicle velocity, vehicle rate of change of velocity, individual wheel speeds, front/rear wheel speeds, vehicle pitch/yaw, etc. Other examples of the components or subassemblies 150 and/or corresponding sensors of the sensor network 160 may provide information relating to yaw, lateral G force, steering wheel angle, throttle position, ride height, selector button positions associated with chassis and/or vehicle control selections, etc.

Accordingly, for example, the controller 140 may be able to receive numerous different parameters, indications and other information that may be related to or indicative of different situations or conditions associated with vehicle status. The controller 140 may also receive information indicative of the intent of the operator 125 (e.g., based on mode selection, steering wheel angle, speed, various functional button or other selectors, etc.) relative to control of various aspects of operation of the vehicle 110 and then be configured to use the information received in association with the execution of one or more control algorithms that may be used to provide instructions to various components of the vehicle 110 in order to control application of the respective components of the vehicle 110.

The wheel assemblies 180 may include multiple individual instances of a wheel assembly (i.e., four such instances). Each instance of the wheel assembly may include suspension components (e.g., suspension links, control arms, tie rods, knuckles, etc.), braking components (e.g., rotor, pads, caliper, drum, shoes, regenerative braking components, etc.), wheel hub, rim, tire, etc.

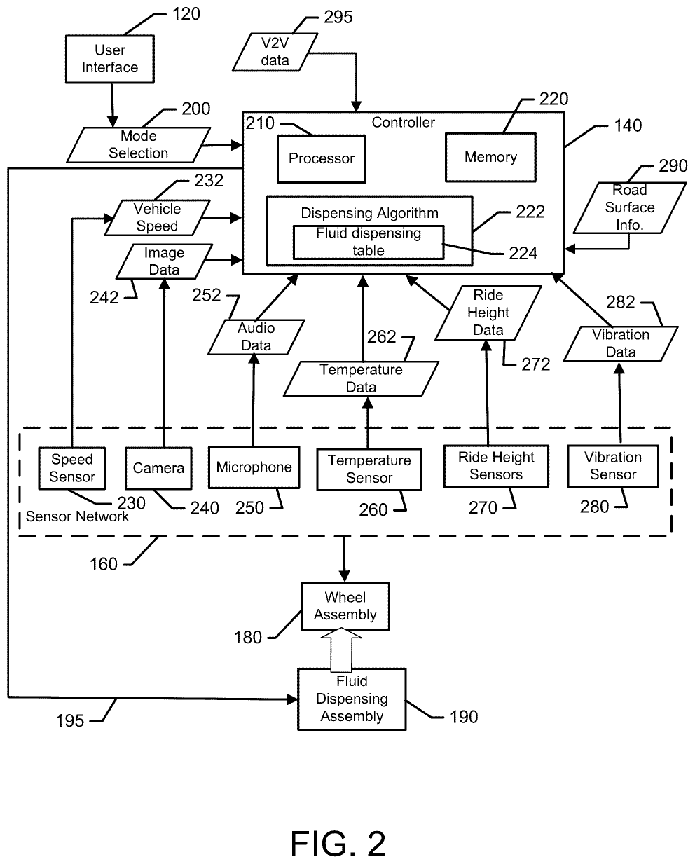

In an example embodiment, the operator 125 may use the user interface 120 to select the wheel assembly cleaning mode, or to simply enable or actuate such functionality. The user interface 120 may be embodied by an interactive display in the vehicle 110, and may therefore be a soft switch provided on the display. However, in other examples, the user interface 120 may include a hard switch, a button, key, or other selectable operator located in the cockpit of the vehicle 110. Selection of the wheel assembly cleaning mode may correspondingly activate or actuate a fluid dispensing assembly 190 to provide the wheel assembly cleaning function described herein based on information provided by the components or subassemblies 150 and/or corresponding sensors of the sensor network 160. More specifically, selection of the wheel assembly cleaning mode may enable automatic or manual control of the fluid dispensing assembly 190 via a trigger signal 195 (or actuation signal) as discussed in greater detail below. Operation of the fluid dispensing assembly 190 will be described in greater detail below in reference to FIG. 2.

Referring now to FIG. 2, operation of the controller 140 of the control system 100 will be described in greater detail. FIG. 2 illustrates a block diagram of various components of the control system 100 in greater detail. In this regard, for example, FIG. 2 illustrates example interactions between the controller 140 and the fluid dispensing assembly 190 relative to information received thereby (e.g., from the sensor network 160, and/or from the user interface 120, which may provide a mode selection 200 input). Processing circuitry (e.g., a processor 210 and memory 220) at the controller 140 may process the information received by running one or more control algorithms. The control algorithms may include instructions that can be stored by the memory 220 for retrieval and execution by the processor 210. In some cases, the memory 220 may further store one or more tables (e.g., look up tables) and various calculations and/or applications may be executed using information in the tables and/or the information as described herein. The control algorithms may, for example, include a dispensing algorithm 222, which may include a fluid dispensing table 224 defining various aspects associated with determining when to issue the trigger signal 195 or calculating an amount or volume of fluid to dispense and/or a temperature or type of fluid to dispense as described in greater detail below.

The processor 210 may be configured to execute the control algorithms in series or in parallel. However, in an example embodiment, the processor 210 may be configured to execute multiple control algorithms in parallel (e.g., simultaneously) and substantially in real time. The control algorithms may be configured to perform various calculations based on the information received/generated regarding specific conditions of vehicle components. The control algorithms may therefore execute various functions based on the information received, and generate outputs (e.g., the trigger signal 195).

In an example embodiment, the controller 140 may include firmware or software enabling the controller 140 to determine when to generate the trigger signal 195 and in some cases, the trigger signal 195 may further include information that defines the amount or volume of fluid to dispense and/or the temperature or type of fluid to dispense based on the information obtained from the sensor network 160 and/or the mode selection 200. The sensor network 160 may also provide various types of sensor data, which will be described in greater detail below.

In an example embodiment, the sensor network 160 may include any of a number of different sensors, each of which may provide a different piece or type of information obtained regarding the environment of the vehicle 110 and/or the wheel assembly 180. Thus, for example, the sensor network 160 may include a speed sensor 230, which may provide vehicle speed data 232 to the controller 140. The vehicle speed data 232 may also be used to determine rate of change of speed, and contributions to motion in various direction. Thus, the speed sensor 230 is just one example of a motion sensor that may be employed in connection with example embodiments to, for example, measure motion (and rates of change of such motion) in the vertical direction and/or horizontal direction, including yaw. A steering wheel sensor may be another example sensor that may be included in the sensor network 160.

The sensor network 160 may also include a camera 240 (or multiple cameras) to provide image data 242 to the controller 140. The camera 240 may be disposed in a wheel well of the vehicle 110 (e.g., proximate the wheel assembly 180 and/or fluid dispensing assembly 190). In such cases, the camera 240 may even be cleaned responsive to operation of the fluid dispensing assembly 190. The camera 240 may also or alternatively be a side view mirror camera, or may view the roadway surface. In such cases, the camera 240 may be used to determine road surface type and/or condition, temperature (e.g., by visual confirmation relative to freezing), precipitation (existence, form, and/or intensity), along with visual evidence of fouling. However, any location, purpose and orientation may be employed. In some cases, multiple instances of the camera 240 may be provided so that, for example, individual wheels (or pairs of wheels on the same side) can be separately inspected visually to determine if a trigger condition is present. For example, if a single wheel is fouled, then the fluid dispensing assembly 190 may be actuated on an individual wheel basis (e.g., for each wheel or in pairs), and only the wheel (or wheels) that qualify for fluid dispensing may receive it in order to save fluid.

The sensor network 160 of some example embodiments may employ one or more instances of a microphone 250, which may be positioned proximate to the wheel assembly 180 to provide audio data 252 to the controller 140. The audio data 252 may be used to determine road surface type and/or condition and, in some cases, may provide an ability to detect when unusual noises, which may be indicative of fouling, can be detected. The sensor network 160 may also or alternatively include a temperature sensor 260, which may provide temperature data 262 to the controller 140. The temperature data 262 may be useful in determining the form of precipitation and, in some cases, may also be used by the dispensing algorithm 222 to determine whether the fluid should be heated prior to being dispensed, or otherwise whether heat application at the wheel assembly 180 may be useful.

In some embodiments, the sensor network 160 may also include ride height sensors 270 to provide ride height data 272, which may be used to determine when ride height is not changing normally (e.g., due to fouling of suspension components or packing of the entire wheel well itself). The sensor network 160 may also or alternatively include a vibration sensor 280, which may provide vibration data 282. The vibration data 282 may be useful for determining when fouling of the wheel assembly 180 is causing unusual or excessive vibration.

It should be appreciated that various ones of the sensors described above in connection with the sensor network 160 may be repeated for each individual instance of the wheel assembly 180. Thus, for example, four microphones 250 (one for each wheel) could be provided. However, in other cases, such as for the temperature sensor 260, it may not be necessary to duplicate sensors for each wheel, since the temperature is presumed to be the same for all wheels. In any case, duplication or consolidation of sensors may be performed to maximize efficiency and accuracy.

In some embodiments, the controller 140 may also receive additional inputs that may not necessarily come directly (or indirectly) from the sensor network 160. In this regard, for example, road surface information 290 could be provided from an external source such as from a mapping service or navigation system, which may record road surface type for each section of road. Additionally or alternatively, various parameters or other pieces of information about a particular section of road may be provided by other vehicles that have traversed (perhaps recently within a predetermined period of time). Such information may be provided directly or indirectly from the other vehicles as vehicle-to-vehicle (V2V) data 295.

Upon receipt of any or all of the information discussed above, which may be provided to the controller 140, the controller 140 may employ the dispensing algorithm 222 to determine whether to actuate the fluid dispensing assembly 190 to dispense fluid on or toward the wheel assembly 180 (or portions thereof). Thus, for example, the dispensing algorithm 222 may determine whether to issue the trigger signal 195 and, in some cases, for which wheel, how long, and whether to include other information (such as identifying the type of fluid to use, if multiple options are available, and temperature, if changing temperature is possible). In an example embodiment, the controller 140 (e.g., via the dispensing algorithm 222) may determine a fluid volume to be dispensed toward the wheel assembly 180. The fluid volume may be determined based, for example, on the fluid dispensing table 224 in some cases. In such cases, prior to activation of flow, the entire amount of fluid that is to be dispensed may be determined. This assumes, of course, that the dispensing amount is not merely a fixed value that always stays the same by default, and therefore necessarily means that among a plurality of or variable amount of fluid volumes that could be dispensed, a calculation of the right amount for the current situation is what is determined by the controller 140. The fluid volume that is calculated can then be turned into parameters (e.g., how long, how much pressure, what direction, etc.) for control of the actuation and termination of flow of the fluid until the fluid volume to be dispensed has been achieved.

The volume determination and type or temperature of fluid to be dispensed (if applicable) may depend on various factors that may be considered via the dispensing algorithm 222 and/or stored in the fluid dispensing table 224. In some cases, the audio data 252, vibration data 282, temperature data 262 and/or road surface information 290 may provide indications as to the type of road surface that is being traversed by the vehicle 110. The type of surface may contribute to the volume, type or temperature determinations and/or whether a trigger condition (i.e., a set of enabling parameters that when detected correspondingly dictate issuance of the trigger signal 195) is detected. In some cases, corresponding trigger conditions may be set for each of various parameters, such as temperature (e.g., a temperature trigger condition), visual data (e.g., an optical trigger condition), vibration (e.g., a vibration trigger condition), etc., and the trigger signal 195 may be generated when a corresponding number (e.g., one, two or three) of the individual parametric trigger conditions is detected. In some of these cases, the dispensing algorithm 222 may be configured to compare various parameters to determine whether any one (or multiple) of the parameters seems to be out of balance or expected ranges for current driving conditions. For example, with respect to ride height data 272, there may be normal wheel excursions that are expected for certain driving conditions. In those cases, if there is an imbalance between the expected wheel excursions based on the surface profile and actual wheel excursions measured by the ride height sensors 270, the controller 140 may trigger actuation of the fluid dispensing assembly 190.

In an example embodiment, the controller 140 may, for example, measure motion in any direction including the vertical direction, along with steering wheel angle information and vibrational frequency. These parameters may be measured and compared to one or more respective thresholds, or a combined threshold, for triggering actuation of the fluid dispensing assembly 190. However, triggering of the fluid dispensing assembly 190 may not always be automated. Instead, as noted above, the operator 125 may actuate or activate the fluid dispensing assembly 190 in some cases via a human-machine interface (HMI) such as the user interface 120. Although operator 125 actuation could be performed at any time the operator 125 desires, some embodiments may include the provision of a notification or recommendation to the operator 125 to initiate the trigger signal 195 (e.g., via mode selection 200).

When automatically generated, the trigger signal 195 may be generated responsive to detection of a corresponding one of many different possible trigger conditions. However, instead of being automatically generated, the trigger signal 195 may be manually initiated by the operator 125 as noted above. When manually initiated in this way, in some cases, the controller 140 may determine an inspection condition has been met, and may provide the notification or recommendation mentioned above to the operator 125. An inspection condition may be generated for many, or even all of the reasons noted above. Thus, for example, the inspection condition could be triggered based on temperature and optical input from the sensor network 160, and the controller 140 may notify the operator 125 of the vehicle 110 that the inspection condition has been detected.

The controller 140 may also be capable of more complicated calculations or determinations in some embodiments. For example, in some cases the controller 140 may (via the dispensing algorithm 222) determine an estimated mass of debris on the wheel assembly 180 based on input from the sensor network 160. The estimated mass may be determined via a table of information recording estimated mass as a function of time and/or mileage of operation in certain conditions (e.g., time, temperature, precipitation type, miles driven, etc.). In such examples, the controller 140 may further determine a volume of fluid to be dispensed for the current estimated mass. Alternatively or additionally, the controller 140 may determine a pressure of fluid to be dispensed, a temperature of fluid to be dispensed, and/or a type of fluid to be dispensed based on the estimated mass of debris. The same volume, temperature, pressure and type determinations may also be made regardless of mass, or in more general terms, as well in some cases. Moreover, in addition to determining that snow or ice has accumulated on the wheel assembly 180 so that fluid should be dispensed, it may be possible that heat generated at the wheel assembly 180 may be useful (e.g., to melt snow and/or ice). Thus, for example, the controller 140 may determine a trigger event associated with accumulation of snow or ice, and further provide a notification to the operator 125 to request braking to generate heat to assist in melting the snow and/or ice.

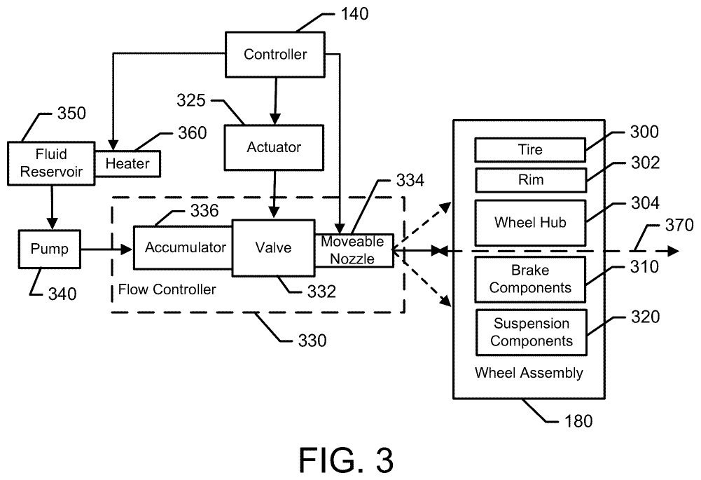

The fluid dispensing assembly 190 may take numerous forms in various example embodiments. Some examples of such forms are shown in FIGS. 3-6, but still others are also possible. Referring first to FIG. 3, a specific structure is shown with a movable target zone or area that means the stream of dispensed fluid may be directed to various different locations within the area of the wheel assembly 180. Various components of the wheel assembly 180 are first shown by way of example. In this regard, the wheel assembly 180 may include a tire 300, which is typically pneumatic, but may be airless in some cases. The tire 300 is typically operably coupled to a wheel rim 302 and/or wheel hub 304. The wheel hub 304 may also be operably coupled to various components of a braking system, which are generally represented in FIG. 3 as brake components 310. The brake components 310 may include the brake rotor, drum, caliper, pads, shoes, or regenerative or other braking components of the vehicle 110. The fluid dispensing assembly 190 may also target suspension components 320 such as tie rods, control arms, suspension linkages, knuckles, and/or the like.

In the example of FIG. 3, the controller 140 may send the trigger signal 195 to an actuator 325, which may operate a flow controller 330. The flow controller 330 may in turn be operably coupled to a pump 340, which may pump fluid from a fluid reservoir 350. Although not required, the fluid inside the fluid reservoir 350 may, in some cases, be heated responsive to operation of a heater 360. In some embodiments, the heater 360 may be operational based on instructions from the controller 140. The fluid within the fluid reservoir 350 may be air, water, or a solvent, such as a solvent that is particularly useful to clean certain substances or melt ice (and is itself an anti-freeze having a very low freezing point).

The flow controller 330 may include its own set of components in some cases. Thus, for example the flow controller 330 may include a valve 332 that is operable between open and closed positions to allow flow through the flow controller 330 in the open position, and prevent such flow in the closed position. When flow is allowed, the flow may pass through movable nozzle 334, which may have its target direction (or aiming point) be changeable based on electronic commands from the controller 140. As such, the movable nozzle 334 may articulate, or otherwise move to change the target direction. In some embodiments, the nozzle 334 may be provided to be in line with a steering axis 370 of the wheel assembly 180. By being in line with the steering axis 370, and being articulated to target angles above and below the steering axis 370 the movable nozzle 334 may cover almost any suitable part of the wheel assembly 180. In some cases, the flow controller 330 may also include an accumulator 336, which may be used to increase a pressure of dispensed fluid to a desired pressure (which may be set by the controller 140).

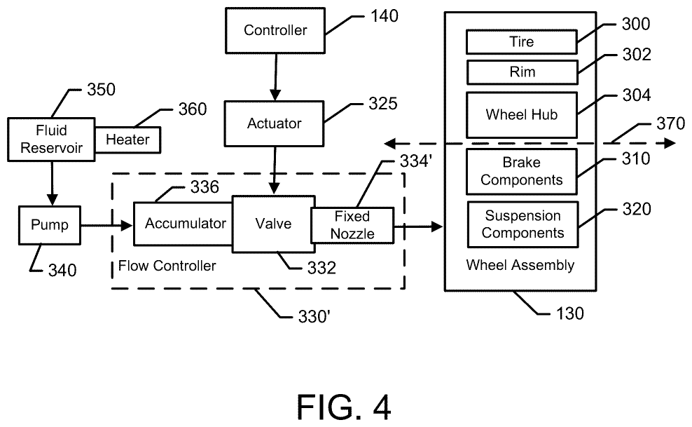

FIG. 4 shows many of the same components of FIG. 3 except that the flow controller 330′ has a different nozzle. In this regard, the nozzle of flow controller 330′ is a fixed nozzle 334′. The fixed nozzle 334′ may have a simpler construction and could, for example, also be provided in line with the steering axis 370 (as shown in FIG. 3), or may be deliberately provided off the steering axis 370 as shown in FIG. 4. One reason to be on the steering axis 370 may be to be sure that there is no need to move the direction of the nozzle even as the wheel itself is turned. However, it may also be desirable in some cases to offset the fixed nozzle 334′ from the steering axis 370 in order to be sure that other parts of the wheel can be sprayed with the fluid through various rotations of the wheel and different steering angles.

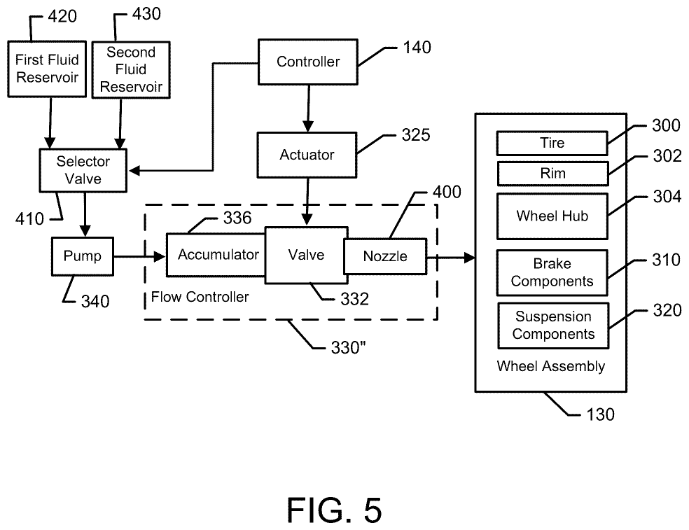

FIG. 5 illustrates still another example embodiment in which multiple different fluids may be employed in respective different fluid reservoirs. Whereas it was noted above that the fluid reservoir 350 may have multiple different types of fluid therein (e.g., water, air of solvent), FIG. 5 demonstrates that a different fluids could be in different respective reservoirs and the flow controller 330″ could apply a selected one of the fluids via a nozzle 400, which could be either fixed or movable. To demonstrate this point, a selector valve 410 is shown operably coupled to the controller 140 and to a first fluid reservoir 420 and second fluid reservoir 430. The first fluid reservoir 420 may be filled with a first fluid (any one of air, water and a solvent), and the second fluid reservoir 430 may be filled with a second fluid (any one of air, water and a solvent) that is different than the first fluid. Additional fluid reservoirs may also be included to provide different fluid options for various different situations and some or all of the additional fluid reservoirs may include heaters. The controller 140 may determine which fluid is called for based on current conditions (or which combination of fluids), and then the controller 140 may apply the selected fluid (or fluids) via selection of each via the selector valve 410. The selector valve 410 may be used to pick the fluid to be applied and then the pump 340 may provide the fluid that is selected to be applied through the flow controller 330″.

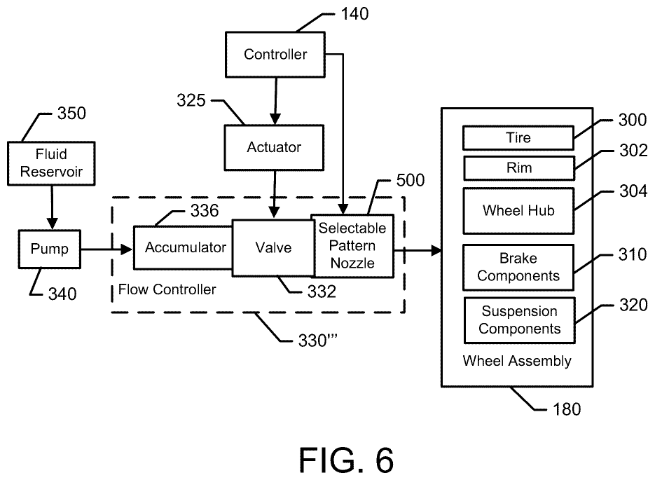

FIG. 6 illustrates still another alternative example in which the controller 140 can be used to select a different spray pattern that from a selectable pattern nozzle 500. In this regard, the selectable pattern nozzle 500 may have different spray patterns such as a jet pattern where a high pressure and focused stream is dispensed, a stream pattern where a normal pressure and focused stream is dispensed, and various spray patterns with respective different target areas and/or spray pattern widths.

Finally, it should be appreciated that the flow controller 330 may be specific to a corresponding one of the wheels. Thus, for example, the fluid reservoir 350 may be common (i.e., used for any wheel) as well as the pump 340. However, a separate instance of the flow controller 330 (and therefore a separate instance of the valve 332 and nozzle) may be provided for each wheel. The actuator 325 may be capable of selecting each respective wheel for actuation, or a separate instance for the actuator 325 may be provided for each respective wheel. The controller 140 may therefore be capable of (via the trigger signal 195) actuating separate valves or separate actuators to provide fluid at each respective one of the wheels when a trigger condition is sensed for that wheel. Alternatively, a trigger condition at any wheel may trigger fluid dispensing at all wheels. It should also be appreciated that when triggering actuation for different wheels, each wheel could receive a different fluid, a different pressure, a different spray pattern, a different temperature and/or a different volume of fluid.

A wheel assembly cleaning system for a vehicle may therefore be provided. The wheel assembly cleaning system may include a sensor network disposed proximate to the wheel assembly to detect fouling inside the wheel assembly, a controller operably coupled to the sensor network to determine a trigger condition associated with detection of the fouling inside the wheel assembly, and a fluid dispensing assembly disposed proximate to an internal side of the wheel assembly to apply a fluid to the inside of the wheel assembly under control of the controller responsive to the trigger condition. The fluid dispensing assembly may include a reservoir of the fluid, a pump providing motive force for application of the fluid, and a flow controller to direct the fluid to the inside of the wheel assembly.

The system of some embodiments may include additional features, modifications, augmentations and/or the like to achieve further objectives or enhance performance of the system. The additional features, modifications, augmentations and/or the like may be added in any combination with each other. Below is a list of various additional features, modifications, and augmentations that can each be added individually or in any combination with each other. For example, the flow controller may include a movable nozzle having a target direction that is changed based on electronic commands from the controller to enable the movable nozzle to be directed at different components of the wheel assembly. In an example embodiment, the movable nozzle may be movable about a central axis, and the central axis may be aligned with a wheel axis of the wheel assembly. In some cases, the system further includes a heating element to heat the fluid, and the controller determines a temperature at which to expel the fluid based on current environmental conditions detected by the sensor network. In an example embodiment, the controller further determines a fluid volume to be dispensed prior to activation of the flow controller and actuates the flow controller to terminate flow of the fluid when the fluid volume to be dispensed has been achieved. In some cases, the flow controller may have a fixed target direction, and the fixed target direction is offset from a wheel axis of the wheel assembly. In an example embodiment, the fluid may be water, a solvent, or air. In some cases, the sensor network may include a temperature sensor to detect a temperature trigger condition, an optical sensor to detect an optical trigger condition, and a vibration sensor to detect a vibration trigger condition, and the controller may require at least two trigger conditions to actuate the flow controller. In an example embodiment, the sensor network may include a temperature sensor and a camera with a viewing aperture directed to a portion of the wheel assembly, and the controller may require a temperature trigger and an optical trigger to actuate the flow controller. In some cases, the sensor network may include ride height sensors and a camera, and the controller may determine a surface profile for a surface on which the vehicle is operating based on image data from the camera. In such an example, responsive to an imbalance between the expected wheel excursions based on the surface profile and actual wheel excursions measured by the ride height sensors, the controller may trigger actuation of the flow controller. In an example embodiment, the sensor network may include a steering wheel position sensor and a motion sensor for measuring motion in a vertical direction, and vibrational frequency may be determined based on steering wheel position and the motion in the vertical direction and compared to a threshold for triggering actuation of the flow controller. In some cases, the flow controller may be automatically actuated based on inputs from the sensor network, and manually actuated by an operator of the vehicle via a human to machine interface disposed in a cabin of the vehicle. In an example embodiment, vehicle to vehicle (V2V) data may be exchanged between vehicles regarding triggering of the controller for actuation of the flow controller in a particular geographic location. In some cases, the controller may determine an inspection condition based on temperature and optical input from the sensor network, and the controller may notify an operator of the vehicle when the inspection condition is determined. In an example embodiment, the controller may determine an estimated mass of debris on the wheel assembly based on input from the sensor network, and the controller may further determine a volume of fluid to be dispensed, a pressure of fluid to be dispensed, a temperature of fluid to be dispensed, and/or a type of fluid to be dispensed based on the estimated mass of debris. In some cases, the controller may determine a trigger event associated with accumulation of snow or ice, and the controller may further provide a notification to an operator of the vehicle to request braking to generate heat responsive to the trigger event. In an example embodiment, the sensor network may include a microphone, and the microphone may detects a sound evaluated by the controller to determine a type of material the wheel assembly is traversing. In some cases, the flow controller may have at least a first selectable spray pattern and a second selectable spray pattern, and the controller may select one of the first or second selectable spray patterns based on wheel speed or type of material the wheel assembly is traversing. In an example embodiment, the flow controller may include a first valve associated with a first wheel, and a second valve associated with a second wheel, and the controller may independently determine whether to actuate the first valve and the second valve based on conditions determined at the first wheel and the second wheel, respectively, via the sensor network.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A wheel assembly cleaning system comprising:
a sensor network disposed proximate to the wheel assembly to detect fouling of the wheel assembly;
a controller operably coupled to the sensor network to determine a trigger condition associated with detection of the fouling inside the wheel assembly; and
a fluid dispensing assembly disposed proximate to an internal side of the wheel assembly to apply a fluid to the inside of the wheel assembly under control of the controller responsive to the trigger condition, the fluid dispensing assembly comprising a reservoir of the fluid, a pump providing motive force for application of the fluid, and a flow controller to direct the fluid to the inside of the wheel assembly.

2. The system of claim 1, wherein the flow controller comprises a movable nozzle having a target direction that is changed based on electronic commands from the controller to enable the movable nozzle to be directed at different components of the wheel assembly.

3. The system of claim 2, wherein the movable nozzle is movable about a central axis, and
wherein the central axis is aligned with a wheel axis of the wheel assembly.

4. The system of claim 1, further comprising a heating element to heat the fluid, and wherein the controller determines a temperature at which to expel the fluid based on current environmental conditions detected by the sensor network.

5. The system of claim 4, wherein the controller further determines a fluid volume to be dispensed prior to activation of the flow controller and actuates the flow controller to terminate flow of the fluid when the fluid volume to be dispensed has been achieved.

6. The system of claim 1, wherein the flow controller has a fixed target direction, and wherein the fixed target direction is offset from a wheel axis of the wheel assembly.

7. The system of claim 1, wherein the fluid comprises water, a solvent, or air.

8. The system of claim 1, wherein the sensor network comprises a temperature sensor to detect a temperature trigger condition, an optical sensor to detect an optical trigger condition, and a vibration sensor to detect a vibration trigger condition, and
wherein the controller requires at least two trigger conditions to actuate the flow controller.

9. The system of claim 1, wherein the sensor network comprises a temperature sensor and a camera with a viewing aperture directed to a portion of the wheel assembly, and
wherein the controller requires a temperature trigger and an optical trigger to actuate the flow controller.

10. The system of claim 1, wherein the sensor network comprises ride height sensors and a camera,
wherein the controller determines a surface profile for a surface on which the vehicle is operating based on image data from the camera, and
wherein, responsive to an imbalance between the expected wheel excursions based on the surface profile and actual wheel excursions measured by the ride height sensors, the controller triggers actuation of the flow controller.

11. The system of claim 1, wherein the sensor network comprises a steering wheel position sensor and a motion sensor for measuring motion in a vertical direction, and
wherein vibrational frequency is determined based on steering wheel position and the motion in the vertical direction and compared to a threshold for triggering actuation of the flow controller.

12. The system of claim 1, wherein the flow controller is automatically actuated based on inputs from the sensor network, and manually actuated by an operator of the vehicle via a human to machine interface disposed in a cabin of the vehicle.

13. The system of claim 1, wherein vehicle to vehicle (V2V) data is exchanged between vehicles regarding triggering of the controller for actuation of the flow controller in a particular geographic location.

14. The system of claim 1, wherein the controller determines an inspection condition based on temperature and optical input from the sensor network, and
wherein the controller notifies an operator of the vehicle when the inspection condition is determined.

15. The system of claim 1, wherein the controller determines an estimated mass of debris on the wheel assembly based on input from the sensor network, and
wherein the controller further determines a volume of fluid to be dispensed, a pressure of fluid to be dispensed, a temperature of fluid to be dispensed, or a type of fluid to be dispensed based on the estimated mass of debris.

16. The system of claim 1, wherein the controller determines a trigger event associated with accumulation of snow or ice, and
wherein the controller further provides a notification to an operator of the vehicle to request braking to generate heat responsive to the trigger event.

17. The system of claim 1, wherein the sensor network comprises a microphone, and
wherein the microphone detects a sound evaluated by the controller to determine a type of material the wheel assembly is traversing.

18. The system of claim 1, wherein the flow controller has at least a first selectable spray pattern and a second selectable spray pattern, and
wherein the controller selects one of the first or second selectable spray patterns based on wheel speed or type of material the wheel assembly is traversing.

19. The system of claim 1, wherein the flow controller comprises a first valve associated with a first wheel, and a second valve associated with a second wheel,
wherein the controller independently determines whether to actuate the first valve and the second valve based on conditions determined at the first wheel and the second wheel, respectively, via the sensor network.

20. A fluid dispensing assembly for cleaning a wheel assembly of a vehicle, the fluid dispensing assembly comprising:
a reservoir of fluid;
a pump operably coupled to the reservoir to provide motive force for application of the fluid; and
a flow controller operably coupled to a controller of the vehicle to direct the fluid to the inside of a wheel assembly of the vehicle responsive to a sensor network disposed proximate to the wheel assembly detecting fouling inside the wheel assembly and the controller determining a trigger condition associated with detection of the fouling inside the wheel assembly.
